(19) United States
(12) Patent Application Publication
(10) Pub. No.: US 2025/0126488 A1
(43) Pub. Date: Apr. 17, 2025

(54) SITE INTEGRATION MANAGEMENT SYSTEM

(71) Applicant: DISH Wireless L.L.C., Littleton, CO (US)

(72) Inventors: Shashank Avvaru, Littleton, CO (US); Kat King, Thornton, CO (US); Muhammad Nabeel Mufti, Littleton, CO (US); Aseem Khanna, Parker, CO (US)

(21) Appl. No.: 18/601,438

(22) Filed: Mar. 11, 2024

Related U.S. Application Data
(60) Provisional application No. 63/589,846, filed on Oct. 12, 2023.

(51) Int. Cl. H04W 24/02; H04W 4/50; H04W 24/04; H04W 84/04

(52) U.S. Cl. CPC H04W 24/02; H04W 4/50; H04W 24/04; H04W 84/042

(57) ABSTRACT

A method of integrating a wireless network site may include receiving a first signal indicating that a component associated with the wireless network site is in a first stage. The method may include verifying that the component associated with the wireless network site is functioning according to the first stage. The method may include determining an entity associated with a second stage, based at least in part on the component associated with the wireless network site and the first stage. The method may include transmitting a signal to the entity, the signal associated with one or more tasks further associated with the second stage. The method may include receiving a second signal indicating that the component associated with the wireless network site is in the second stage. The method may include verifying that the component associated with the wireless network site is functioning according to the second stage.

### CROSS REFERENCE TO RELATED APPLICATIONS

This application claims priority to U.S. Provisional Patent Application No. 63/589,846, filed on Oct. 12, 2023, the disclosure of which is incorporated by reference in its entirety for all purposes.

### BACKGROUND

Wireless network sites may include several components all managed by different responsible parties. Furthermore, components managed by one entity may be dependent upon components managed by another entity. The interdependence of components needed for a single wireless network site may present logistical challenges in work flow, leading to inefficiencies and failures.

### BRIEF SUMMARY

A method of integrating a wireless network site may include receiving, by a computing system, a first signal indicating that a component associated with the wireless network site is in a first stage. The method may include verifying, by the computing system, that the component associated with the wireless network site is functioning according to the first stage. The method g may include, in response to verifying that the component associated with the wireless network is functioning according to the first stage, determining, by the computing system, an entity associated with a second stage, based at least in part on the component associated with the wireless network site and the first stage. The method may include transmitting, by the computing system, a signal to the entity, the signal associated with one or more tasks further associated with the second stage. The method may include receiving, by the computing system, a second signal indicating that the component associated with the wireless network site is in the second stage. The method may include verifying, by the computing system, that the component associated with the wireless network site is functioning according to the second stage.

In some embodiments, the method may include determining, by the computing system, that the component is not functioning according to the second stage. The method may include accessing, by the computing system, data associated with the first stage and the second stage. The method may include determining, by the computing system, an entity associated with the second stage. The method may include transmitting, by the computing system, a repair order to the entity associated with the second stage.

In some embodiments, the wireless network site may include component associated with a standalone 5G network. The standalone 5G network may include an open radio access network. The component associated with the wireless network site may include one or more network components hosted on a publicly available cloud network. The component associated with the wireless network site may include at least one of a server, a radio unit, and an antenna. The first stage may include installing one or more radio units at the wireless network site. The second stage may include provisioning a compute instance with one or more network functions associated with a 5G network.

A system for integrating a wireless network site may include one or more processors and a non-transitory computer-readable medium. The non-transitory computer-readable medium may include instructions that, when executed by the one or more processors, cause the system to perform operations. According to the operations, the system may receive a first signal indicating that a component associated with the wireless network site is in a first stage. The system may verify that the component associated with the wireless network site is functioning according to the first stage. In response to verifying that the component associated with the wireless network is functioning according to the first stage, The system may determine an entity associated with a second stage, based at least in part on the component associated with the wireless network site and the first stage. The system may transmit a signal to the entity, the signal associated with one or more tasks further associated with the second stage. The system may receive a second signal indicating that the component associated with the wireless network site is in the second stage, and verify that the component associated with the wireless network site is functioning according to the second stage.

In some embodiments, the wireless network site may include component associated with a standalone 5G network. The standalone 5G network may include an open radio access network. The component associated with the wireless network site may include one or more network components hosted on a publicly available cloud network. The component associated with the wireless network site may include at least one of a server, a radio unit, and an antenna. The first stage may include installing one or more radio units at the wireless network site. The second stage may include provisioning a compute instance with one or more network functions associated with a 5G network.

A non-transitory computer-readable medium may include instructions that, when executed by one or more processors, cause the one or more processors to perform operations. The operations may include receiving, by a computing system, a first signal indicating that a component associated with a wireless network site is in a first stage. The operations may include verifying, by the computing system, that the component associated with the wireless network site is functioning according to the first stage. The operations may include, in response to verifying that the component associated with the wireless network is functioning according to the first stage, determining, by the computing system, an entity associated with a second stage, based at least in part on the component associated with the wireless network site and the first stage. The operations may include transmitting, by the computing system, a signal to the entity, the signal associated with one or more tasks further associated with the second stage. The operations may include receiving, by the computing system, a second signal indicating that the component associated with the wireless network site is in the second stage. The operations may include verifying, by the computing system, that the component associated with the wireless network site is functioning according to the second stage.

### BRIEF DESCRIPTION OF THE DRAWINGS

FIG. 1 illustrates a system and a method for integrating a wireless network site, according to certain embodiments.

FIG. 2 illustrates a system including an orchestrator for integrating a wireless network site, according to certain embodiments.

FIG. 3 illustrates a flowchart of a method 300 for integrating a wireless network site, according to certain embodiments.

FIG. 4A illustrates an embodiment of a cellular network system, according to certain embodiments.

FIG. 4B illustrates an exemplary core, according to certain embodiments.

FIG. 5 illustrates an embodiment of a cellular network core network topology as implemented on a public cloud-computing platform, according to certain embodiments.

### DETAILED DESCRIPTION

Wireless network sites include complex collections of both hardware and software components. On-site, a wireless network site may include components such as servers, radio units, antennas, and various other electronic devices. Each of the components may have software components associated with the component, both on-site and off-site (e.g., hosted by a publicly-available cloud computing network). Furthermore, the wireless network site may include multiple software-based components (e.g., network functions) that are purely cloud-based while being associated with the wireless network site.

Each of the components—both hardware and software—may be associated with a particular entity, responsible for installing, provisioning, and maintaining one or more respective components. When establishing a new wireless network site, each of these entities may install their respective components. However, some components associated with a first entity may be dependent upon a component associated with a second entity. For example, a first entity may install and run network functions of a distributed unit (DU). Before the DU can be brought online, however, hardware components (e.g., a server) may need to be provisioned any set up by a second entity. A host may also need to be provisioned on the hardware components by a third entity before the DU can be brought online. If the first entity attempted to bring the DU online before the second and third entity installed their respective components, the first entity may fail in their attempt. In some cases, the failure may be easily tracked and identified; a missing piece of hardware may be easily identified even before the first entity attempted to install the DU. Other failures may be harder to detect, such as an element of the hardware components being installed incorrectly, yet still available for configuration (e.g., a server being plugged in incorrectly, yet still appearing available to receive programs such as the DU).

Generally, the multiple entities needed to integrate a new wireless network site into a wireless network may have installed or attempted to install their respective components at or near the same amount of time. As some of the components are dependent on others, however, having entities attempting to perform tasks such as installing their respective components may be inefficient and/or lead to unnecessary failures and errors. Therefore, an order may be established, where each of the entities install and/or provision their various components according to a predetermined schedule. In other words, the wireless network site may brought online (or integrated) in various stages. As each stage is completed, a computing system may verify that all components are functioning appropriately for that stage. After verifying that all components are functioning appropriately, the computing system may generate a work signal corresponding to the next stage in the process of integrating the wireless network site. The work signal may be transmitted to entities needed to install various components associated with the next stage. This process may be repeated until the wireless network site is fully integrated, and all components of the wireless network site are functioning appropriately.

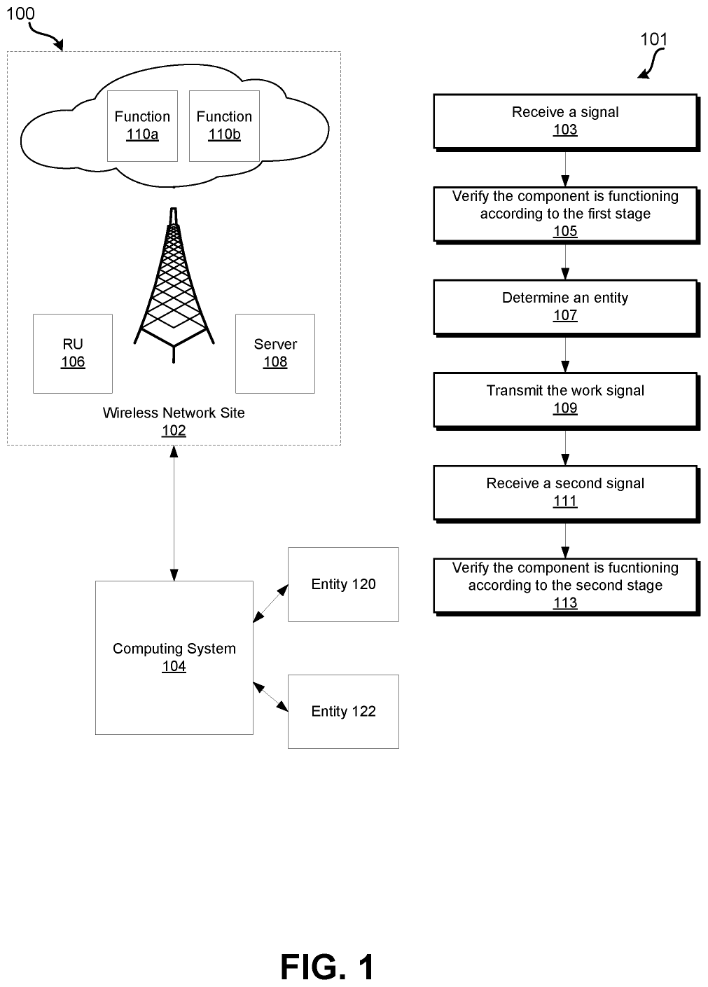

FIG. 1 illustrates a system 100 and a method 101 for integrating a wireless network site 102, according to certain embodiments. The system 100 may include the wireless network site 102 and a computing system 104. The wireless network site 102 may include various software and/or network components physically located at the wireless network site 102, such as a radio unit (RU) 106 and a server 108. The wireless network site 102 may also include various network functions located off-site (e.g., hosted by a cloud services provider) such as network functions 110a-b. The wireless network site 102 and components thereof may be part of a 5G wireless network, providing wireless service to multiple user equipments. The 5G wireless network may be an open radio access network (O-RAN) implemented in a distributed cloud architecture via a publicly available cloud services provider.

A first stage of an integration process may include installing and provisioning the RU 106 and the server 108. For example, an entity 120 (such as a technician) may install the RU 106 to a tower at the wireless network site 102. The entity 120 (or a different entity) may install the server 108 at the wireless network site 102. Although only the RU 106 and the server 108, it should be understood that the wireless network site 102 may include any number of other components, both hardware and software. Once the RU 106 and the server 108 are installed, they may be configured by being physically and/or electronically connected to other components or other such configuration steps. After the first stage is completed, other entities may perform their respective tasks/provide their respective components.

At 103, the computing system 104 may receive a signal indicating that components associated with the wireless network site 102 is functioning according to the first stage. The signal may be received from the entity 120, indicating that the work done by the entity 120 has been completed and that the various components associated with the entity 120 are functioning appropriately. The signal may additionally or alternatively be received from a component of the wireless network site 102. For example, the entity 120 may provision the wireless network site 102 with the server 108. After being provisioned, the server 108 may transmit the signal to the computing system 104 that the server 108 is online. The signal may indicate that the server 108 is communicating with one or more other components of the wireless network site 102 (e.g., the RU 106).

In some embodiments, the component (e.g., the server 108) and the entity 120 may transmit a respective signal to the computing system 104. The respective signals may indicate that the component(s) of the wireless network site 102 are functioning according to the first stage. Alternatively, the respective signals may indicate different statuses. For example, the entity 120 may transmit a first respective signal to the computing system 104 indicating that the server 108 is provisioned and functioning appropriately (i.e., the entity 120 has completed a task). The server 108 may transmit a second respective signal indicating that an error has occurred (e.g., the server 108 cannot communicate with the RU 106 or some other component). In response, the computing system 104 may generate and transmit a work signal to the entity 120 to repair the server 108, such that all components are functioning according to the first stage.

At 105, the computing system 104 may verify that the component is functioning according to the first stage. The computing system 104 may send a test signal to the server 108 such that the server 108 performs one or more actions. The one or more actions may be actions expected to be completed according to the first stage. For example, the server 108 may be expected to be able to send and receive signals with the RU 106. According to the test signal, the server 108 may attempt to send and/or receive a signal to the RU 106. If the server 108 fails, the server 108 may indicate that the test failed to the computing system 104. If the test is successful, the server 108 may so indicate to the computing system 104.

At 107, the computing system 104 determine an entity 122 associated with a second stage, based at least in part on the components associated with the first stage. For example, the entity 122 may be associated with the network functions 110a-b. The computing system 104 may identify that the network functions 110a-b are able to be properly instantiated and brought online, due in part to the server 108 functioning according to the first stage. Thus, the computing system 104 may determine that the entity 122 should instantiate the network functions 110a-b according to the second stage.

At 109, the computing system 104 may transmit a work signal associated with the second stage to the entity 122. For example, the work signal may indicate that the network functions 110a-b are to be instantiated. The entity 122 may then cause the network functions 110a-b to be instantiated and/or configure various components of the wireless network site 102 according to the second stage.

At 111, the computing system 104 may receive a second signal indicating that the components of the wireless network site 102 are in the second stage. The signal may be received from the entity 122, indicating that the work done by the entity 122 has been completed and that the various components (e.g., the network functions 110a-b) associated with the entity 122 are functioning appropriately. The signal may additionally or alternatively be received from a component of the wireless network site 102. For example, the entity 122 may instantiate the network functions 110a-b wireless network site 102 via a cloud service. The server 108 may connect with the network functions 110a-b to verify that the network functions 110a-b are functioning appropriately. The server 108 may then transmit the signal to the computing system 104 that the network functions 110a-b are communicating with the server 108 and functioning properly.

At 113, the computing system 104 may verify that the component(s) associated with the wireless network site 102 is functioning according to the second stage. The computing system 104 may send a test signal to the network functions 110a-b to ensure that the wireless network site 102 is operating appropriately. The computing system 104 may also send a test signal to the server 108 and the RU 106, ensuring all components of the wireless network site 102 are operating appropriately. The computing system 104 may also determine that the wireless network site 102 is radiating as expected (e.g., providing wireless service) and cause the wireless network site 102 to be in a “live” condition.

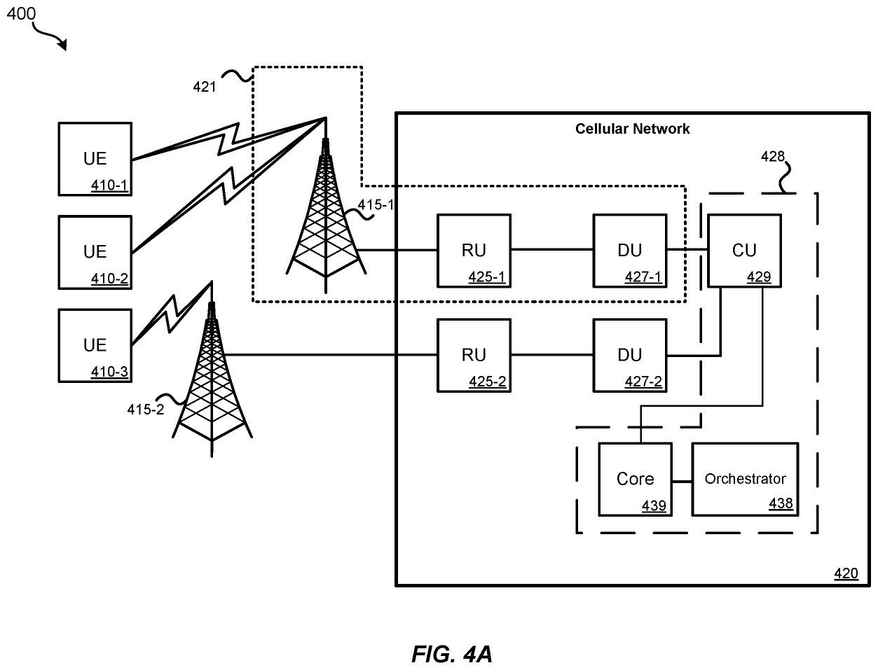

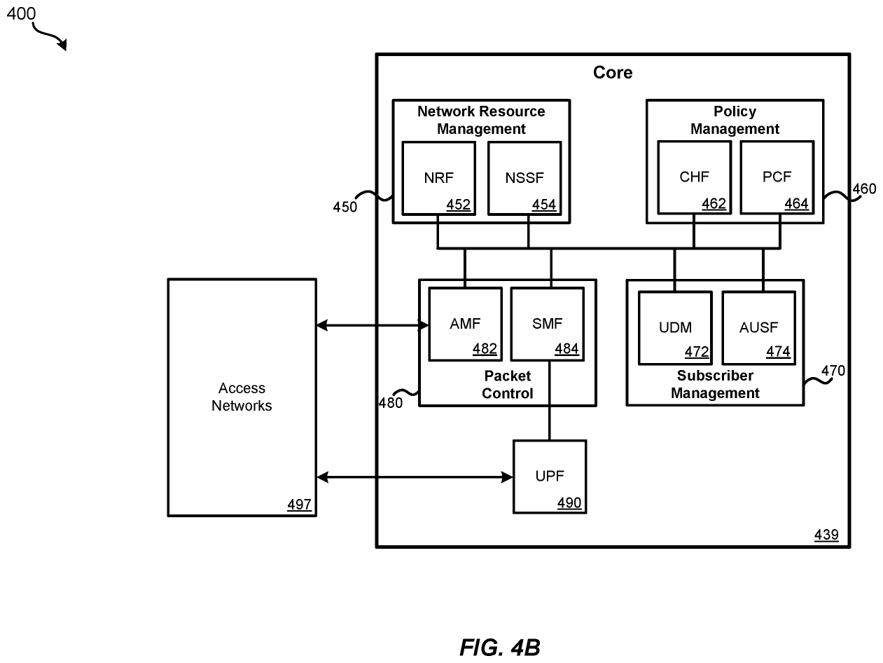

The components and functions described above are presented merely as examples. The wireless network site 102 may include any or all of the components needed for a wireless network service, such as those presented in FIGS. 4A-B. Similarly, the network functions 110a- may be 5G network functions, as described herein, or may be any other software component for providing a wireless network. One of ordinary skill in the art would recognize many possibilities and configurations.

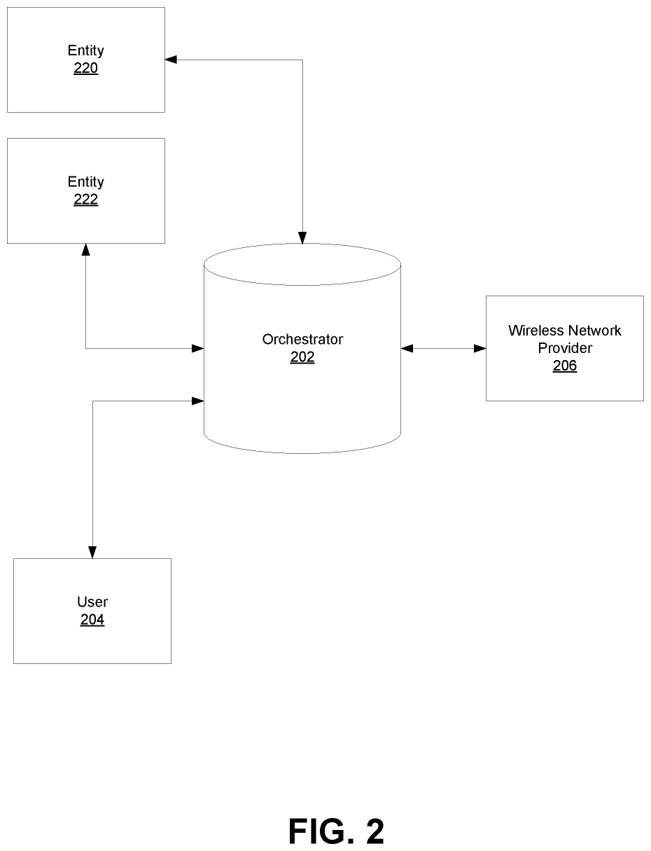

FIG. 2 illustrates a system 200 including an orchestrator 202 for integrating a wireless network site, according to certain embodiments. The orchestrator 202 may be implemented on a computing system such as the computing system 104. The orchestrator 202 may be in communication with a user 204, entities 220-222, and a wireless network provider 206. The user 204 may be associated with at least one of the entities 220 and 222 and/or the wireless network provider 206. The user 204 may provide data to the orchestrator indicating one or more stages of a wireless network site's integration (e.g., a server must be installed first, then a host may be installed, then a network function, etc.). The user 204 may also indicate any unique requirements associated with the wireless network site (e.g., due to location, etc.).

Using the data provided by the user 204, the orchestrator 202 may determine which of the entities 220-222 are required at which stage. The orchestrator 202 may then send a work signal to the entity 220 to indicate that one or more components associated with the entity 220 may be installed. The orchestrator 202 may base the work signal on a previous stage of the integration of the wireless network site, a verification that the components of the wireless network are functioning appropriately, an error message, or some other such indicator. The orchestrator 202 may then send a second work signal to the entity 222, indicate that one or more components associated with the entity 222 may be installed. The second work signal may be transmitted after the first work signal or at the same time.

The orchestrator 202 may receive signals indicating a status of the components from the entities 220-222. For example, the orchestrator 202 may receive indications that the components associated with each of the entities 220-222 are functioning according to the appropriate stage. The orchestrator 202 may in turn transmit the signals to the wireless network provider 206 and/or update a database to include the indications. In some embodiments, the orchestrator 202 may cause a test to be performed on the wireless network site, verifying that the components are functioning properly. Based on the results of the verification, the orchestrator 202 can send work signals to the appropriate entities and/or the wireless network provider.

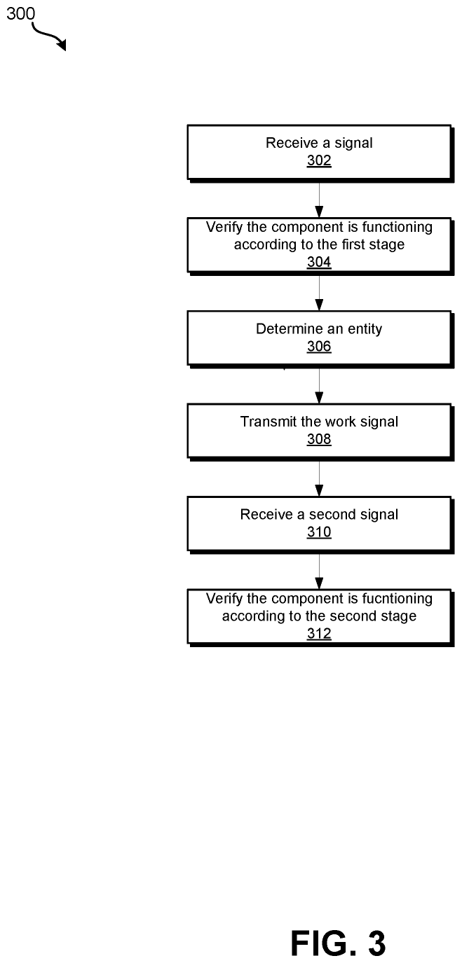

FIG. 3 illustrates a flowchart of a method 300 for integrating a wireless network site, according to certain embodiments. The method 300 may be performed by some or all of the systems described herein, such as the systems 100 and 200 in FIGS. 1 and 2, respectively. Some or all of the steps of the method 300 may be performed in a different order than that presented herein, or may be combined with other steps. In some embodiments, some steps may be skipped altogether.

At step 302, the method 300 may include receiving, by a computing system, a first signal indicating that a component associated with a wireless network site is in a first stage. The wireless network site may be similar to the wireless network site 102 in FIG. 1. The component may be a hardware and/or software component used to provide wireless services (e.g., a 5G wireless network) via the wireless network site. For example, the component may be a server such as the server 108. The signal may then indicate that the server has been installed appropriately and is in communication with one or more other components of the wireless network site. The signal may be received from an entity associated with the component and/or the first stage, and/or the signal may be received from the component itself. The first stage may include installing one or more RUs, antennas, servers, and/or other such hardware at the wireless network site.

At step 304, the method 300 may include verifying, by the computing system, that the component associated with the wireless network site is functioning according to the first stage. In verifying that the component is functioning according to the first stage, the computing system may transmit a test signal to one or more components of the wireless network site. According to the test signal, the one or more components may perform test functions to determine if all components are functioning as expected (e.g., according to the first stage). If one or more components fail to perform the test function, the component may indicate that the test failed to the computing system. If the test is successful, the component may so indicate to the computing system.

In response to verifying that the component associated with the wireless network site is functioning according to the first stage, at step 306, the method 300 may include determining, by the computing system, an entity associated with a second stage. The entity may be determined based at least in part on the component associated with the wireless network site and/or the first stage. For example, the entity may be associated with a software component dependent upon work performed by a first entity during the first stage. After the computing system verifies that the component of the wireless network site is functioning properly after the work performed by a first entity during the first stage, the computing device may then determine that the software component may be installed at the wireless network site.

At step 308, the method 300 may include transmitting, by the computing system, a work signal to the entity associated with the second stage. The work signal may identify one or more tasks for the entity to complete associated with the wireless network site. (e.g., installing a software component or hardware components, configuring a component, etc.). Upon sending the work signal, the computing system may also update a database to reflect that work is being done on the wireless network site to bring the wireless network site to the second stage.

At step 310, the method may include receiving, by the computing system, a second signal indicating that the component associated with the wireless network site is in the second stage. For example, the signal may indicate that the component has been installed appropriately and is in communication with one or more other components of the wireless network site (e.g., that the work performed by the entity is complete). The signal may be received from an entity associated with the component and/or the first stage, and/or the signal may be received from the component itself.

At step 312, the method 300 may include verifying, by the computing system, that the component associated with the wireless network site is functioning according to the second stage. The computing device may send a test signal to various components of the network site to ensure that the wireless network site is operating appropriately. The computing device may also determine that the wireless network site is radiating as expected (e.g., providing wireless service) and cause the wireless network site to be in a “live” condition.

In some embodiments, the computing system may determine that the component is not functioning according to the second stage. For example, the test signal may fail to reach one or more of the components of the wireless network site and/or one or more components may fail to perform a test function appropriately. The computing system may then access data associated with at least one of the first stage and the second stage. In relation to FIG. 2, the orchestrator 202 may access the database to determine a parameter for the component based on which stage the wireless network site is in. The computing system may then determine the entity(ies) likely to be responsible for the component in the stage the wireless network site is in. The computing system may then transmit a repair order to the responsible entity, indicating the component and/or an error causing the component to not function according to the second stage.

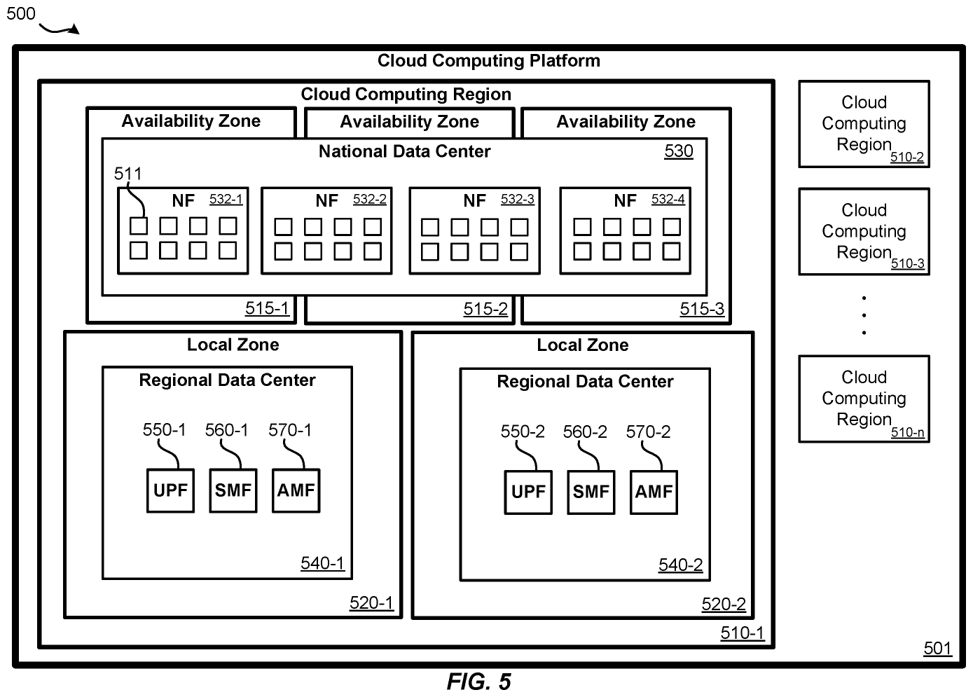

FIG. 4A illustrates an embodiment of a cellular network system 400 (“system 400”), according to certain embodiments. System 400 can include a fifth generation (5G) New Radio (NR) cellular network; other types of cellular networks, such as fourth generation (4G) long-term evolution (LTE) cellular network, sixth generation (6G) cellular network, seventh generation (7G) cellular network, etc. are also possible. System 400 can include: UE 410 (UE 410-1, UE 410-2, UE 410-3); base station 415; cellular network 420; radio units 425 (“RUs 425”); distributed units 427 (“DUs 427”); centralized unit 429 (“CU 429”); core 439, and orchestrator 438. FIG. 4A represents a component level view. In a virtualized open radio access network (O-RAN), because components can be implemented as software in the cloud, except for components that receive and transmit RF, the functionality of various components can be shifted among different servers, for which the hardware may be maintained by a separate (e.g., public) cloud-service provider, to accommodate where the functionality of such components is needed, such as detailed in relation to FIG. 5.

UE 410 can represent various types of end-user devices, such as smartphones, cellular modems, cellular-enabled computerized devices, sensor devices, manufacturing equipment, gaming devices, access points (APs), any computerized device capable of communicating via a cellular network, etc. UE can also represent any type of device that has incorporated a cellular (e.g., 5G) interface, such as a 5G modem. Examples include sensor devices, Internet of Things (IoT) devices, manufacturing robots; unmanned aerial (or land-based) vehicles, network-connected vehicles, environmental sensors, etc. UE 410 may use RF to communicate with various base stations of cellular network 420. Two base stations 415 (BS 415-1, 415-2) are illustrated. Real-world implementations of system 400 can include many (e.g., hundreds, thousands) base stations, and many RUs, DUs, and CUs. BS 415 can include one or more antennas that allow RUs 425 to communicate wirelessly with UEs 410. RUs 425 can represent an edge of cellular network 420 where data is transitioned to wireless communication. In some implementations, the radio access technology (RAT) used by RU 425 is 5G New Radio (NR). Other implementations use other RAT, such as 4G Long Term Evolution (LTE). The remainder of cellular network 420 may be based on an exclusive 5G architecture, a hybrid 4G/5G architecture, a 4G architecture, or some other cellular network architecture. Base station equipment 421 may include an RU (e.g., RU 425-1) and a DU (e.g., DU 427-1) located on site at the base station. In some embodiments, the DU may be physically remote from the RU. For instance, multiple DUs may be housed at a central location and connected to geographically distant (e.g., within a couple of kilometers) RUs.

One or more RUs, such as RU 425-1, may communicate with DU 427-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, “band 71” (a radiofrequency band near 600 Megahertz allocated for cellular communications). One or more DUs, such as DU 427-1, may communicate with CU 429. Collectively, RUs, DUs, and CUs create a gNodeB, which serves as the radio access network (RAN) of cellular network 420. CU 429 can communicate with core 439. The specific architecture of cellular network 420 can vary by embodiment. Edge cloud server systems outside of cellular network 420 may communicate, either directly, via the Internet, or via some other network, with components of cellular network 420. For example, one or more DUs 427-1 may be able to communicate with an edge cloud server system without routing data through CU 429 or core 439.

At a high level, the various components of a gNodeB can be understood as follows: RUs perform RF-based communication with UE. DUs support lower layers of the protocol stack such as the radio link control (RLC) layer, the medium access control (MAC) layer, and the physical communication layer. CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can communicate with multiple RUs.

Further detail regarding exemplary core 439 is provided in relation to FIG. 4B. FIG. 4B illustrates an exemplary core 439, according to certain embodiments. The exemplary core 439 can be physically distributed across data centers or located at a central national data center (NDC), such as detailed in relation to FIG. 5, can perform various core functions of the cellular network. Core 439 can include: network resource management components 450; policy management components 460; subscriber management components 470; and packet control components 480. Individual components may communicate via a bus, thus allowing various components of core 439 to communicate with each other directly. Core 439 is simplified to show some key components. Implementations can involve additional components.

Network resource management components 450 can include: Network Repository Function (NRF) 452 and Network Slice Selection Function (NSSF) 454. NRF 452 can allow 5G network functions (NFs) to register and discover each other via a standards-based application programming interface (API). NSSF 454 can be used by AMF 482 to assist with the selection of a network slice that will serve a particular UE (e.g., UEs 410 of FIG. 4A).

Policy management components 460 can include: Charging Function (CHF) 462 and Policy Control Function (PCF) 464. CHF 462 allows charging services to be offered to authorized network functions. Converged online and offline charging can be supported. PCF 464 allows for policy control functions and the related 5G signaling interfaces to be supported.

Subscriber management components 470 can include: Unified Data Management (UDM) 472 and Authentication Server Function (AUSF) 474. UDM 472 can allow for generation of authentication vectors, user identification handling, NF registration management, and retrieval of UE individual subscription data for slice selection. AUSF 474 performs authentication with UEs.

Packet control components 480 can include: Access and Mobility Management Function (AMF) 482 and Session Management Function (SMF) 484. AMF 482 can receive connection-and session-related information from UEs and is responsible for handling connection and mobility management tasks. SMF 484 is responsible for interacting with the decoupled data plane, creating updating and removing Protocol Data Unit (PDU) sessions, and managing session context with the User Plane Function (UPF).

User plane function (UPF) 490 can be responsible for packet routing and forwarding, packet inspection, quality of service (QOS) handling, and external PDU sessions for interconnecting with a Data Network (DN) (e.g., the Internet) or various access networks 497. Access networks 497 can include the RAN of cellular network 420 of FIG. 4A.

While FIGS. 4A and 4B illustrate various components of cellular network 420, it should be understood that other embodiments of cellular network 420 can vary the arrangement, communication paths, and specific components of cellular network 420. While RU 425 may include specialized radio access componentry to enable wireless communication with UE 410, other components of cellular network 420 may be implemented using either specialized hardware, specialized firmware, and/or specialized software executed on a general-purpose server system. In a virtualized arrangement, specialized software on general-purpose hardware may be used to perform the functions of components such as DU 427, CU 429, and core 439. Functionality of such components can be co-located or located at disparate physical server systems. For example, certain components of core 439 may be co-located with components of CU 429.

Returning to FIG. 4A, some O-RAN implementations of the DUs 427, CU 429, core 439, and/or orchestrator 438 are implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 400, cloud-based cellular network components 428 include CU 429, core 439, and orchestrator 438. In some embodiments, DUs 427 may be partially or fully added to cloud-based cellular network components 128. Such cloud-based cellular network components 128 may be executed as specialized software executed by underlying general-purpose computer servers. Cloud-based cellular network components 128 may be executed on a public third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested. A “public” cloud-based computing platform refers to a platform where various unrelated entities can each establish an account and separately utilize the cloud computing resources, the cloud computing platform managing segregation and privacy of each entity's data.

Kubernetes, or some other container orchestration platform, can be used to create and destroy the logical DU, CU, or 5G core units and subunits, as needed, for the cellular network 420 to function properly. Kubernetes allows for container deployment, scaling, and management. As an example, if cellular traffic increases substantially in a region, an additional logical DU or components of a DU may be deployed in a data center near where the traffic is occurring without any new hardware being deployed; rather, processing and storage capabilities of the data center would be devoted to the needed functions. When the need for the logical DU or subcomponents of the DU no longer exists (i.e., when traffic subsequently decreases), Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 438. Orchestrator 438 can represent various software processes executed by underlying computer hardware. Orchestrator 438 can monitor cellular network 420 and determine the amount and location at which cellular network functions should be deployed to meet or attempt to meet service level agreements (SLAs) across slices of the cellular network.

Orchestrator 438 can allow for the instantiation of new cloud-based components of cellular network 420. As an example, to instantiate a new DU, orchestrator 438 can perform a pipeline of calling the DU code from a software repository incorporated as part of, or separate from, cellular network 420; pulling corresponding configuration files (e.g., helm charts); creating Kubernetes nodes/pods; loading DU containers; configuring the DU; and activating other support functions (e.g., Prometheus, instances/connections to test tools).

A network slice functions as a virtual network operating on cellular network 420. Cellular network 420 is shared with some number of other network slices, such as hundreds or thousands of network slices. Communication bandwidth and computing resources of the underlying physical network can be reserved for individual network slices, thus allowing the individual network slices to reliably meet particular service level agreement (SLA) levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, such allocations also account for resource limitations, such as to avoid allocation of an excess of resources to any particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 425-1 and DU 427-1; and a second set of network slices, which may only partially overlap or may be wholly different from the first set, may be reserved at RU 425-2 and DU 427-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

As illustrated in FIG. 4A, UE 410 may be operating on one or more production slices of cellular network 420. As detailed later in this document, a UE that functions on a particular entity's local network may be assigned to a slice particular to the entity or a slice that provides a particular QoE for tasks to be performed by the entity's UE.

Components such as DUs 427, CU 429, orchestrator 438, and core 439 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

FIG. 5 illustrates an embodiment of a cellular network core network topology 500 as implemented on a public cloud-computing platform, according to certain embodiments. The cellular network core network topology 500 can be an implementation of the core 439 of FIG. 4A and/or 4B. Cellular network core network topology 500 can represent how logical cellular network groups are distributed across cloud computing infrastructure of cloud computing platform 501. Cloud computing platform 501 can be logically and physically divided up into various different cloud computing regions 510. Each of cloud computing regions 510 can be isolated from other cloud computing regions to help provide fault tolerance, fail-over, load-balancing, and/or stability and each of cloud computing regions 510 can be composed of multiple availability zones, each of which can be a separate data center located in general proximity to each other (e.g., within 600 miles). Further, each of cloud computing regions 510 may provide superior service to a particular geographic region based on physical proximity. For example, cloud computing region 510-1 may have its datacenters and hardware located in the northeast of the United States while cloud computing region 510-2 may have its datacenters and hardware located in California. For simplicity, the details of the cellular network as executed in only cloud computing region 510-1 is illustrated. Similar components may be executed in other cloud computing regions of cloud computing regions 510 (510-2, 510-3, 510-n).

In other embodiments, cloud computing platform 501 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 510 may include multiple availability zones 515. Each of availability zones 515 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 515. For example, a database that is maintained as part of NDC 530 may be replicated across availability zones 515; therefore, if an availability zone of the cloud computing region is unavailable, a copy of the database remains up-to-date and available, thus allowing for continuous or near continuous functionality.

On a (e.g., public) cloud computing platform, cloud computing region 510-1 may include the ability to use a different type of data center or group of data centers, which can be referred to as local zones 520. For instance, a client, such as a provider of the hybrid cloud cellular network, can select from more options of the computing resources that can be reserved at an availability zone 515 compared to a local zone 520. However, a local zone 520 may provide computing resources nearby geographic locations where an availability zone 515 is not available. Therefore, to provide low latency, certain network components, such as regional data centers 540, can be implemented at local zones 520 rather than availability zones 515. In some circumstances, a geographic region can have both a local zone 520 and an availability zone 515.

In the topology of a 5G NR cellular network, 5G core functions of core 439 can logically reside as part of a national data center (NDC) 530. NDC 530 can be understood as having its functionality existing in cloud computing region 510-1 across multiple availability zones 515. At NDC 530, various network functions, such as NFs 532, are executed. For illustrative purposes, each NF 532, whether at NDC 530 or elsewhere located, can be comprised of multiple sub-components, referred to as pods (e.g., pod 511) that are each executed as a separate process by the cloud computing region 510. The illustrated number of pods 511 is merely an example; fewer or greater numbers of pods 511 may be part of the respective 5G core functions. It should be understood that in a real-world implementation, a cellular network core, whether for 5G or some other standard, can include many more network functions. By distributing NFs 532 across availability zones 515, load-balancing, redundancy, and fail-over can be achieved. In local zones 520, multiple regional data centers 540 can be logically present. Each of regional data centers 540 may execute 5G core functions for a different geographic region or group of RAN components. As an example, 5G core components that can be executed within an RDC, such as RDC 540-1, may be: UPFs 550, SMFs 560, and AMFs 570. While instances of UPFs 550 and SMFs 560 may be executed in local zones 520, SMFs 560 may be executed across multiple local zones 520 for redundancy, processing load-balancing, and fail-over.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks. For example, executing instructions stored in the non-transitory computer-readable medium causes the processors to perform steps of methods and/or to implement features of components described herein.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method of integrating a wireless network site comprising:
receiving, by a computing system, a first signal indicating that a component associated with the wireless network site is in a first stage;
verifying, by the computing system, that the component associated with the wireless network site is functioning according to the first stage;
in response to verifying that the component associated with the wireless network is functioning according to the first stage:
determining, by the computing system, an entity associated with a second stage, based at least in part on the component associated with the wireless network site and the first stage;
transmitting, by the computing system, a signal to the entity, the signal associated with one or more tasks further associated with the second stage;
receiving, by the computing system, a second signal indicating that the component associated with the wireless network site is in the second stage; and
verifying, by the computing system, that the component associated with the wireless network site is functioning according to the second stage.

2. The method of claim 1, further comprising:
determining, by the computing system, that the component is not functioning according to the second stage;
accessing, by the computing system, data associated with the first stage and the second stage;
determining, by the computing system, an entity associated with the second stage; and
transmitting, by the computing system, a repair order to the entity associated with the second stage.

3. The method of claim 1, wherein the wireless network site comprises component associated with a standalone 5G network.

4. The method of claim 3, wherein the standalone 5G network comprises a open radio access network.

5. The method of claim 1, wherein the component associated with the wireless network site comprises one or more network components hosted on a publicly-available cloud network.

6. The method of claim 1, wherein the component associated with the wireless network site comprises at least one of a server, a radio unit, and an antenna.

7. The method of claim 1, wherein the first stage includes installing one or more radio units at the wireless network site.

8. The method of claim 1, wherein the second stage includes provisioning a compute instance with one or more network functions associated with a 5G network.

9. A system for integrating a wireless network site, comprising:
one or more processors; and
a non-transitory computer-readable medium comprising instructions that, when executed by the one or more processors, cause the system to perform operations to:
receive a first signal indicating that a component associated with the wireless network site is in a first stage;
verify that the component associated with the wireless network site is functioning according to the first stage;
in response to verifying that the component associated with the wireless network is functioning according to the first stage:
determine an entity associated with a second stage, based at least in part on the component associated with the wireless network site and the first stage;
transmit a signal to the entity, the signal associated with one or more tasks further associated with the second stage;
receive a second signal indicating that the component associated with the wireless network site is in the second stage; and
verify that the component associated with the wireless network site is functioning according to the second stage.

10. The system of claim 9, wherein the wireless network site comprises component associated with a standalone 5G network.

11. The system of claim 9, wherein the standalone 5G network comprises a open radio access network.

12. The system of claim 9, wherein the component associated with the wireless network site comprises one or more network components hosted on a publicly available cloud network.

13. The system of claim 9, wherein the component associated with the wireless network site comprises at least one of a server, a radio unit, and an antenna.

14. The system of claim 9, wherein the first stage includes installing one or more radio units at the wireless network site.

15. The system of claim 9, wherein the second stage includes provisioning a compute instance with one or more network functions associated with a 5G network.

16. A non-transitory computer-readable medium comprising instructions that, when executed by a processor, cause the processor to perform operations comprising:
receiving, by a computing system, a first signal indicating that a component associated with a wireless network site is in a first stage;
verifying, by the computing system, that the component associated with the wireless network site is functioning according to the first stage;
in response to verifying that the component associated with the wireless network is functioning according to the first stage:
determining, by the computing system, an entity associated with a second stage, based at least in part on the component associated with the wireless network site and the first stage;
transmitting, by the computing system, a signal to the entity, the signal associated with one or more tasks further associated with the second stage;
receiving, by the computing system, a second signal indicating that the component associated with the wireless network site is in the second stage; and
verifying, by the computing system, that the component associated with the wireless network site is functioning according to the second stage.

17. The non-transitory computer-readable medium of claim 16, wherein wireless network comprises a 5G wireless network.

18. The non-transitory computer-readable medium of claim 16, wherein the component associated with the wireless network site comprises one or more network components hosted on a publicly available cloud network.

19. The non-transitory computer-readable medium of claim 16, wherein the component associated with the wireless network site comprises at least one of a server, a radio unit, and an antenna.

20. The non-transitory computer-readable medium of claim 16, wherein the first stage includes installing one or more radio units at the wireless network site.
